(19) United States
(12) Patent Application Publication
(10) Pub. No.: US 2006/0266294 A1
(43) Pub. Date: Nov. 30, 2006

(54) Animal sleeping bag

(75) Inventors: Cynthia K. Holmes, Costa Mesa, CA (US); Kay E. Crouch, Fountain Valley, CA (US)

Correspondence Address: STETINA BRUNDA GARRED & BRUCKER, 75 ENTERPRISE, SUITE 250, ALISO VIEJO, CA, 92656, US

(73) Assignee: KaCi Distributors

(21) Appl. No.: 11/138,190

(22) Filed: May 26, 2005

(51) Int. Cl. A01K 1/035

(52) U.S. Cl. 119/28.5

(57) ABSTRACT

A pet sleeping bag comprising outer and inner sleeves which each define an interior compartment and a neck which communicates with the interior compartment. The inner sleeve is disposed within the interior compartment of the outer sleeve, with portions of the inner and outer sleeves adjacent the necks thereof being attached to each other in a manner wherein the necks of the outer and inner sleeves collectively define a neck of the sleeping bag. The neck of the sleeping bag communicates with the interior compartment of the inner sleeve which defines the location in the sleeping bag in which a pet normally sleeps or rests.

### CROSS-REFERENCE TO RELATED APPLICATIONS

Not Applicable

### STATEMENT RE: FEDERALLY SPONSORED RESEARCH/DEVELOPMENT

Not Applicable

### BACKGROUND OF THE INVENTION

The present invention relates generally to pet products, and more particularly to a sleeping bag which us uniquely configured to accommodate a household animal such as a dog, cat or ferret.

As is well known to pet owners, indoor pets such as dogs and cats typically have a favorite location in a house or apartment in which to sleep or rest. Often, these locations are a soft chair seat, a bed, or some other location of the house that is undesirable to have the pet habitually rest. As a result, many pet owners have provided baskets, beds, pillows or other comfortable habitats for their pet, which are usually conveniently located for the pet and which are in a location out of the primary activity areas for the individuals of the household.

While currently known dog and cat beds and other similar items are useful, they typically possess certain deficiencies which detract from their overall utility. More particularly, certain prior art pet beds include a frame which is fabricated from a hard material such as wicker or plastic, and a soft insert such as a pillow or blanket material which is inserted into the frame. These relatively rigid structures are sometimes inconvenient to handle and are often not comfortable for the pet since the pillow or blanket material insert typically does not extend along and cover the otherwise hard or rigid sides of the frame. Moreover, these particular types of pet beds do not provide any means for the pet to burrow under a layer of material to keep warm. In this regard, since the typical indoor pet frequently becomes used to household temperatures in the range from about 65° F. to about 75° F., the exposure of the pet to lower outside temperatures or the need to have the pet sleep in a lower temperature area of the house or apartment is likely to cause the pet to become chilled and potentially more susceptible to sickness.

Other commonly used pet beds include baskets which are made in their entirety from a soft material (e.g., foam rubber enclosed or encased in a fabric cover), and pet pillows. Though these baskets and pillows overcome some of the drawbacks associated with those pet beds which include a rigid frame, they too suffer from the lack of any means or structure to allow the pet to burrow under a layer of material to keep warm.

The present invention addresses the deficiencies of currently known pet beds by providing a uniquely configured pet sleeping bag which provides the comfort and security of currently known pet beds, but with the added feature of completely covering the pet in a manner providing a level of warmth far exceeding that provided by such known pet beds. These and other attributes and advantages of the present invention will be discussed in more detail below.

### BRIEF SUMMARY OF THE INVENTION

In accordance with the present invention, there is provided a pet sleeping bag comprising outer and inner sleeves which each define an interior compartment and a neck which communicates with the interior compartment. The inner sleeve is disposed or nested within the interior compartment of the outer sleeve. Additionally, portions of the outer and inner sleeves adjacent the necks thereof are attached to each other in a manner wherein such necks collectively define a neck of the sleeping bag. The neck of the sleeping bag communicates with the interior compartment of the inner sleeve which defines the interior compartment of the overall sleeping bag in which a pet will normally sleep or rest. These portions of the outer and inner sleeves adjacent the necks thereof which are secured to each other represent the only point of attachment therebetween, thus allowing the inner sleeve to be selectively pulled to an inside-out orientation relative to the outer sleeve. An elongate boning strip wrapped into a coiled configuration is preferably used to facilitate the attachment of the outer and inner sleeves to each other. The boning strip is operative to maintain the neck of the sleeping bag collectively defined by the necks of the outer and inner sleeves in a normally open position.

The pet sleeping bag of the present invention is preferably fabricated from an acrylic fur material. Additionally, the outer and inner sleeves are each preferably fabricated from a plurality of separate panels which are sewn or otherwise attached to each other in a prescribed arrangement or pattern. In one embodiment of the present invention, certain panels of each of the outer and inner sleeves are attached to each other by gather stitches which effectively constrict or reduce the width or diameter of the neck of the sleeping bag to a more desirable dimension, yet effectively maximize the width or length of that portion of the interior compartment of the sleeping bag in which the pet normally sleeps or rests. The effective reduction in the width or diameter of the neck of the sleeping bag assists in allowing the same to be easily maintained in the open configuration by the boning strip. These and other features of the present invention will be discussed in more detail below.

### BRIEF DESCRIPTION OF THE DRAWINGS

These, as well as other features of the present invention, will become more apparent upon reference to the drawings wherein:

FIGS. 1 and 2 are top perspective views of a pet sleeping bag constructed in accordance with the present invention;

FIG. 3 is a front perspective view of the pet sleeping bag shown in FIGS. 1 and 2;

FIG. 4 is a cross-sectional view taken along line 4-4 of FIG. 3;

FIG. 5 is an exploded view of the pet sleeping bag shown in FIG. 3, illustrating with particularity the inner and outer sleeves of the sleeping bag;

FIG. 6 is a front perspective view of the outer sleeve of the pet sleeping bag shown in FIG. 5;

FIG. 7 is an exploded view of the outer sleeve of the pet sleeping bag, the inner sleeve having the same construction as the outer sleeve; and

FIG. 8 is a top plan view of the various panels included in both the inner and outer sleeves of the pet sleeping bag of the present invention.

### DETAILED DESCRIPTION OF THE INVENTION

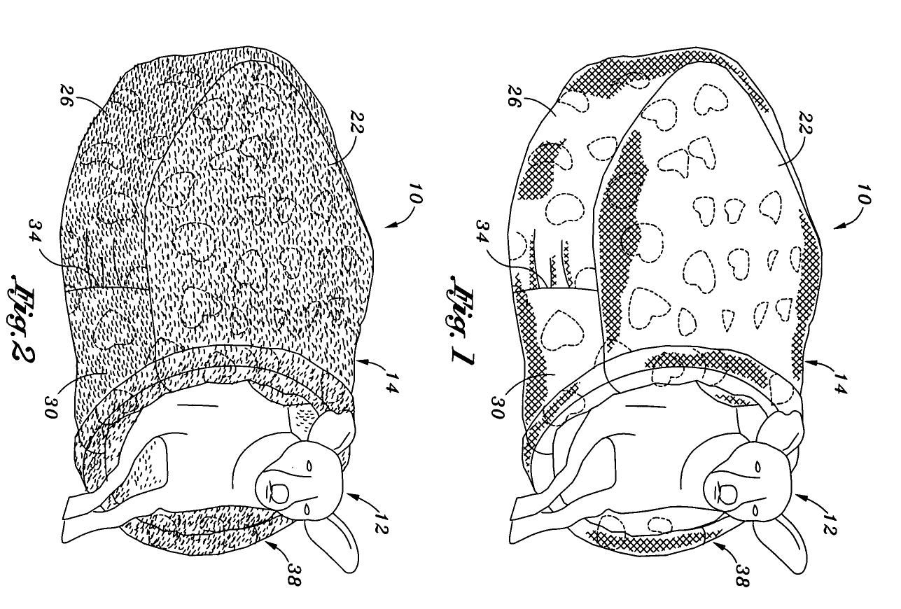

Referring now to the drawings wherein the showings are for purposes of illustrating a preferred embodiment of the present invention only, and not for purposes of limiting the same, FIGS. 1, 2 and 3 provide perspective views of a pet sleeping bag 10 constructed in accordance with the present invention. The sleeping bag 10 of the present invention is specifically suited for use in accommodating a household pet such as a dog 12 (shown in FIGS. 1 and 2), cat or ferret. In this regard, those of ordinary skill in the art will recognize that the sleeping bag 10 as will be described in more detail below may be fabricated in any one of a variety of different sizes corresponding to the size of the dog 12 or cat for which the sleeping bag 10 is to be used. Further, it is contemplated that the sleeping bag 10 of the present invention may be fabricated from any one of a variety of different materials, one exemplary material being shown in FIG. 1 and a second exemplary material being shown in FIG. 2. One preferred material for the sleeping bag 10 is an acrylic fur (woven or knitted) which provides the desirable attributes of comfort, durability, warmth and washability. However, those of ordinary skill in the art will recognize that the sleeping bag 10 may be fabricated from any one of a wide range of different materials, or through the use of various combinations of different materials.

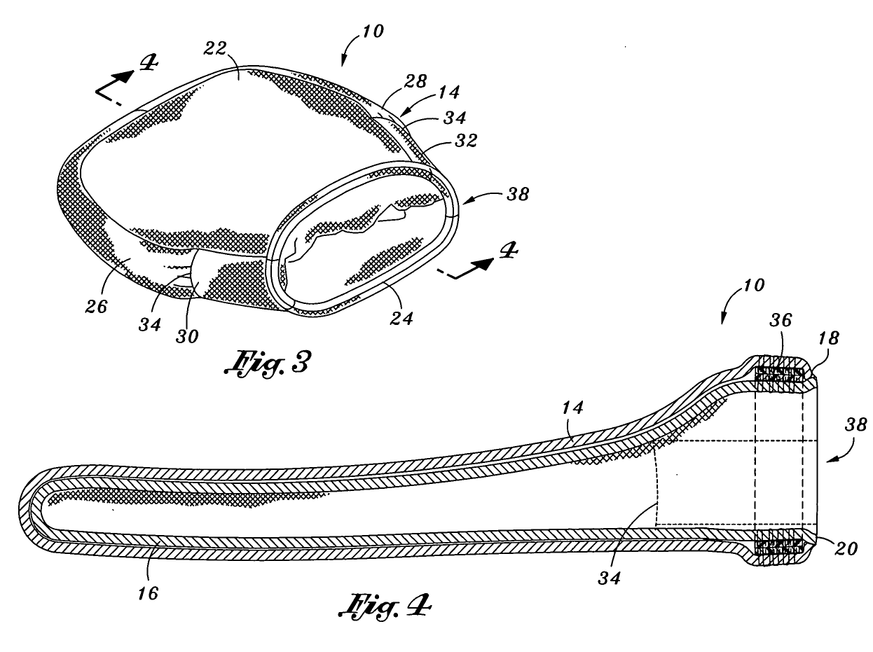

As seen in FIGS. 3-6, the sleeping bag 10 comprises a bag-like outer sleeve 14 and a bag-like inner sleeve 16 which is positioned or nested within the interior of the outer sleeve 14. The outer and inner sleeves 14, 16 are virtually identical in structure and construction as will be discussed in more detail below. The outer sleeve 14 includes a neck 18 which provides access to an interior compartment defined thereby. Similarly, the inner sleeve 16 includes a neck 20 which also provides access to an interior compartment defined thereby.

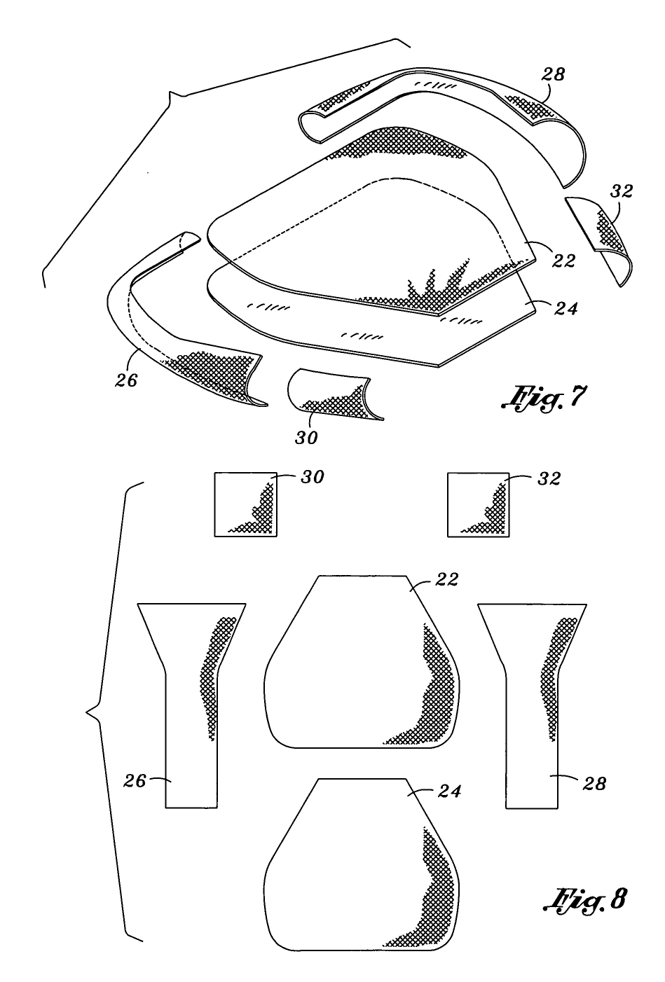

Referring now to FIGS. 7 and 8, the outer and inner sleeves 14, 16 are each fabricated from a plurality of panels which are secured to each other in a prescribed arrangement or pattern. More particularly, included in both the outer and inner sleeves 14, 16 is a first (top) panel 22 and a second (bottom) panel 24. The first and second panels 22, 24 are substantially identically configured to each other. In addition to the first and second panels 22, 24, included in both the outer and inner sleeves 14, 16 is a first side panel 26 and a second side panel 28, the first and second side panels 26, 28 also being substantially identically configured to each other. As is best seen in FIG. 8, the first and second side panels 26, 28 are each configured such that one end portion is outwardly flared, thus resulting in one of the lateral sides or edges being of a width which exceeds that of the remaining, opposed lateral side or edge. In addition to the panels 22, 24, 26, 28, the outer and inner sleeves 14, 16 each further include first and second neck panels 30, 32 which each have a generally quadrangular (e.g., square) configuration.

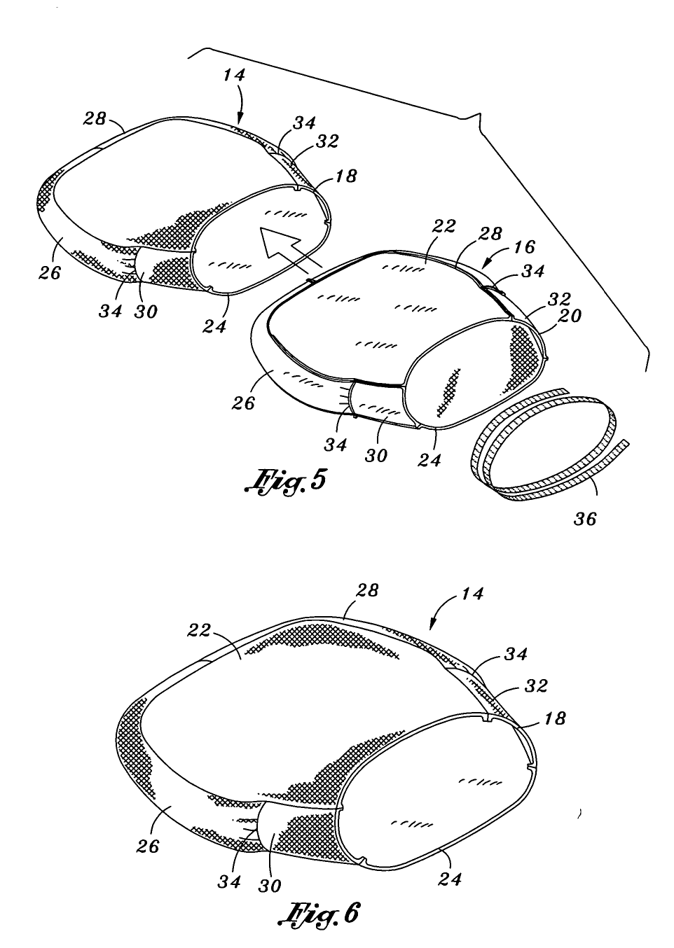

Referring now to FIGS. 5-7, the outer and inner sleeves, 14, 16 of the sleeping bag 10 are fabricated by sewing or otherwise securing the panels 22, 24, 26, 28, 30, 32 to each other after they are placed in the relative orientations best shown in FIG. 7. More particularly, the top longitudinal edges of the first and second side panels 26, 28 are secured (e.g., sewn) to portions of the peripheral edge of the first panel 22, with the bottom longitudinal edges of the first and second side panels 26, 28 being secured to portions of the peripheral edge of the second panel 24. In this regard, the first and second side panels 26, 28 are attached to the first and second panels 22, 24 such that the lateral edges of the first and second side panels 26, 28 of increased width are disposed closest to, but spaced from, those sections or segments of the peripheral edges of the first and second panels 22, 24 which will ultimately partially define the necks 18, 20 of respective ones of the outer and inner sleeves 14, 16. The remaining lateral edges of the first and second side panels 26, 26 of lesser width are attached to each other.

Similar to the first and second side panels 26, 28, the top edges of the first and second neck panels 30, 32 are each attached (e.g., sewn) to a portion of the peripheral edge of the first panel 22, with the bottom edges of the first and second neck panels 30, 32 each being attached to a portion of the peripheral edge of the second panel 24. One side edge of the first neck panel 30 is attached to the adjacent lateral edge of the first side panel 26, with one side edge of the second neck panel 32 being attached to the adjacent lateral edge of the second side panel 28. The first and second neck panels 30, 32 are sized such that those side edges thereof which are not attached to respective ones of the first and second side panels 26, 28 extend to but do not overlap those peripheral edge segments of the first and second panels 22, 24 which will ultimately partially define respective ones of the necks 18, 20. Thus, as will be recognized, the necks 18, 20 of the outer and inner sleeves 14, 16 are each collectively defined by those side edges of the first and second neck panels 30, 32 which are not attached to respective ones of the first and second side panels 26, 28, and those segments of the peripheral edges of the first and second panels 22, 24 which are not attached to either the first and second side panels 26, 28 or the first and second neck panels 30, 32.

As is most apparent from FIGS. 7 and 8, the side edges of the first and second neck panels 30, 32 which are attached to respective ones of the adjacent first and second side panels 26, 28 are each of a width which is less than that of those lateral edges of the first and second side panels 26, 28 to which they are attached. This disparity in width is attributable to the flared configuration of the first and second side panels 26, 28 as described above. As a result of this disparity, a gather stitch 34 is used to attach the first neck panel 30 to the first side panel 26, and to attach the second neck panel 32 to the second side panel 28. As a result of the inclusion of the gather stitches 34 therein, the outer sleeve 14 and inner sleeve 16 each have a final configuration wherein the first and second side panels 26, 28 are flared slightly outwardly relative to respective ones of the first and second neck panels 30, 32 in the manner best shown in FIGS. 3, 5 and 6. Thus, in each of the outer and inner sleeves 14, 16, that portion of the interior compartment which is immediately adjacent the neck 18, 20 is slightly constricted or of reduced width in comparison to the remainder of the interior compartment which extends rearwardly from the gather stitches 34 toward the seam between the attached lateral edges of the first and second side panels 26, 28. Advantageously, with this particular configuration of the interior compartment in each of the outer and inner sleeves 14, 16, the necks 18, 20 thereof may be formed to be of a smaller diameter which is advantageous for reasons to be discussed in more detail below.

The panels 22, 24, 26, 28, 30, 32 used to fabricate each of the outer and inner sleeves 14, 16 in the aforementioned manner are themselves each preferably fabricated from the above-described acrylic fur material. Such acrylic fur material has a soft, furry side and a non-furry side. In fabricating the outer sleeve 14, the furry side of the acrylic fur material is to the outside, with the non-furry side thus defining the interior compartment of the outer sleeve 14. In contrast, the inner sleeve 16 is inside-out in comparison to the outer sleeve 14 such that the non-furry side of the acrylic fur material is to the outside in the inner sleeve 16, with the interior compartment of the inner sleeve 16 being defined by the furry side of the acrylic fur material.

In constructing the sleeping bag 10, the inner sleeve 16 is advanced into the interior compartment of the outer sleeve 14 in the manner shown in FIG. 5. Due to the relative configurations of the outer and inner sleeves 14, 16, when the inner sleeve 16 is advanced into the interior compartment of the outer sleeve 14, the non-furry side of the inner sleeve 16 is directly adjacent to and contacts the non-furry side of the outer sleeve 14. Thus, the exposed exterior surface of the resultant sleeping bag 10 is defined by the furry side of the outer sleeve 14, with the interior compartment of the resultant sleeping bag 10 actually being defined by the interior compartment of the inner sleeve 16 and hence the furry side thereof.

As further seen in FIG. 4, once the inner sleeve 16 has been fully advanced into the outer sleeve 14, portions of the outer and inner sleeves 14, 16 adjacent the necks 18, 20 thereof are secured to each other through the use of an elongate boning strip 36. An exemplary boning strip 36 is commercially available under the trademark RIGILENE®. As best seen in FIGS. 4 and 5, the boning strip 36 is attached by stitching to both the outer and inner sleeves 14, 16 and is maintained in a coiled configuration therebetween. More particularly, the boning strip 36 is sewn directly to portions of the first and second panels 22, 24 and portions of the first and second neck panels 30, 32. The boning strip 36 is operative to maintain the neck 38 of the sleeping bag 10 collectively defined by portions of the outer and inner sleeves 14, 16 in an open position allowing for easy entry and exit of a pet into the interior compartment of the sleeping bag 10. As explained above, the interior compartment of the sleeping bag 10 in which the pet sleeps or rests is actually defined by the interior compartment of the inner sleeve 16.

Importantly, the boning strip 36 represents the only point of attachment between the outer and inner sleeves 14, 16. As a result, the inner sleeve 16 may be selectively turned inside-out relative to the outer sleeve 14 which is advantageous for purposes of washing the sleeping bag 10 and thoroughly cleaning the furry side of the inner sleeve 16 with which the pet is most often in direct contact. Because the exposed exterior surface of the sleeping bag 10 (defined by the outer sleeve 14) is also furry, the pet is provided with the same level of comfort even when sleeping or resting on the exterior surface rather sleeping or resting within the interior compartment of the sleeping bag 10. Indeed, in hot or warm conditions, the pet may well choose to sleep on the exterior surface of the sleeping bag 10, rather than seeking added warmth by crawling into the interior compartment thereof.

As indicated above, the preferred modality used to secure the various panels 22, 24, 26, 28, 30, 32 together is by sewing using seams in the range of about ¼ inch to about ½ inch. By including the first and second side panels 26, 28 between the first and second panels 22, 24 in each of the outer and inner sleeves 14, 16 as opposed to simply attaching portions of the peripheral edges of the first and second panels 22, 24 directly to each other, more clearance is provided for the pet when it enters the interior compartment of the sleeping bag 10, thus providing a less constricted feel for the pet. Additionally, the joined first and second side panels 26, 28 provide a side surface along which the pet may extend its body when within the interior compartment of the sleeping bag 10. Further, the inclusion of the separate first and second side panels 26, 28 as opposed to one continuous side panel allows for the construction of the outer sleeve 14 in a manner wherein the grain of the exposed furry side of the acrylic fur material may run in the same direction, thus providing a more desirable aesthetic or appearance for the sleeping bag 10. The aesthetic attribute of the grain of the acrylic fur material running in the same direction may typically only be achieved as a result of the split configuration of the first and second side panels 26, 28 described above.

As indicated above, due to the inclusion of the gather stitches 34 in the outer and inner sleeves 14, 16, the necks 18, 20 of the outer and inner sleeves 14, 16, and hence the neck 38 of the sleeping bag 10, may be formed to be of smaller diameter in comparison to the interior compartment of the sleeping bag 10. The slightly constricted neck 38 of the sleeping bag 10, while providing plenty of open area to allow for the easy entry of the pet into the interior compartment of the sleeping bag 10 and exit from therewithin, lessens the escape of heat from within the interior compartment and provides the pet therein with a more secure, snug feel. Further, the smaller diameter of the neck 38 makes the same more easy to maintain in an open configuration through the use of the boning strip 36.

Additional modifications and improvements of the present invention may also be apparent to those of ordinary skill in the art. Thus, the particular combination of parts described and illustrated herein is intended to represent only certain embodiments of the present invention, and is not intended to serve as limitations of alternative devices within the spirit and scope of the invention.

What is claimed is:

1. A pet sleeping bag, comprising:
an outer sleeve defining an interior compartment and a neck which communicates with the interior compartment; and
an inner sleeve defining an interior compartment and a neck which communicates with the interior compartment; and
the inner sleeve being disposed within the interior compartment of the outer sleeve, with portions of the inner and outer sleeves adjacent the necks thereof being attached to each other in a manner wherein portions of the inner and outer sleeves collectively define a neck of the sleeping bag which communicates with the interior compartment of the inner sleeve.

2. The pet sleeping bag of claim 1 wherein the portions of the inner and outer sleeves adjacent the necks thereof are attached to each other by an elongate boning strip which is sized and configured to normally maintain the neck of the sleeping bag in an open position.

3. The pet sleeping bag of claim 1 wherein the inner and outer sleeves are each fabricated from an acrylic fur material.

4. The pet sleeping bag of claim 3 wherein:
the acrylic fur material has a furry side and a non-furry side;
the outer sleeve is fabricated such that the interior compartment thereof is defined by the non-furry side of the acrylic fur material and an exterior surface of the outer sleeve is defined by the furry side of the acrylic fur material; and
the inner sleeve is fabricated such that the interior compartment thereof is defined by the furry side of the acrylic fur material and an exterior surface of the inner sleeve is defined by the non-furry side of the acrylic fur material.

5. The pet sleeping bag of claim 1 wherein the outer and inner sleeves are each fabricated from a plurality of panels which are attached to each other in a prescribed pattern.

6. The pet sleeping bag of claim 5 wherein the outer and inner sleeves each comprise:
a first panel defining a peripheral edge;
a second panel defining a peripheral edge;
a first side panel having opposed first and second lateral edges, a top longitudinal edge attached to a portion of the peripheral edge of the first panel, and a bottom longitudinal edge attached to a portion of the peripheral edge of the second panel; and
a second side panel having opposed first and second lateral edges, a top longitudinal edge attached to a portion of the peripheral edge of the first panel, and a bottom longitudinal edge attached to a portion of the peripheral edge of the second panel;
the first lateral edges of the first and second side panels being attached to each other.

7. The pet sleeping bag of claim 6 wherein the outer and inner sleeves each further comprise:
a first neck panel having a side edge attached to the second lateral edge of the first side panel, a top edge attached to a portion of the peripheral edge of the first panel, and a bottom edge attached to a portion of the peripheral edge of the second panel; and
a second neck panel having a side edge attached to the second lateral edge of the second side panel, a top edge attached to a portion of the peripheral edge of the first panel, and a bottom edge attached to a portion of the peripheral edge of the second panel.

8. The pet sleeping bag of claim 7 wherein:
the second lateral edges of the first and second side panels are each of a first width;
the side edges of the first and second neck panels are each of a second width which is less than the first width; and
the side edges of the first and second neck panels are attached to respective ones of the second lateral edges of the first and second side panels by gather stitches.

9. The pet sleeping bag of claim 8 wherein the first and second panels, the first and second side panels, and the first and second neck panels are each fabricated from an acrylic fur material.

10. The pet sleeping bag of claim 9 wherein:
the acrylic fur material has a furry side and a non-furry side;
the outer sleeve is fabricated such that the interior compartment thereof is defined by the non-furry side of the acrylic fur material and an exterior surface of the outer sleeve is defined by the furry side of the acrylic fur material; and
the inner sleeve is fabricated such that the interior compartment thereof is defined by the furry side of the acrylic fir material and an exterior surface of the inner sleeve is defined by the non-furry side of the acrylic fur material.

11. A pet sleeping bag, comprising:
an outer sleeve fabricated from a plurality of panels which are attached to each other in a manner defining an interior compartment; and
an inner sleeve fabricated from a plurality of panels which are attached to each other in a manner defining an interior compartment; and
the inner sleeve being disposed within the interior compartment of the outer sleeve, with portions of the inner and outer sleeves being attached to each other in a manner wherein portions of the inner and outer sleeves collectively define a neck of the sleeping bag which communicates with the interior compartment of the inner sleeve.

12. The pet sleeping bag of claim 11 wherein the portions of the inner and outer sleeves are attached to each other by an elongate boning strip which is sized and configured to normally maintain the neck of the sleeping bag in an open position.

13. The pet sleeping bag of claim 11 wherein the inner and outer sleeves are each fabricated from an acrylic fur material.

14. The pet sleeping bag of claim 13 wherein:
the acrylic fur material has a furry side and a non-furry side;
the outer sleeve is fabricated such that the interior compartment thereof is defined by the non-furry side of the acrylic fur material and an exterior surface of the outer sleeve is defined by the furry side of the acrylic fur material; and
the inner sleeve is fabricated such that the interior compartment thereof is defined by the furry side of the acrylic fur material and an exterior surface of the inner sleeve is defined by the non-furry side of the acrylic fur material.

15. The pet sleeping bag of claim 11 wherein the outer and inner sleeves each comprise:
a first panel defining a peripheral edge;
a second panel defining a peripheral edge;
a first side panel having opposed first and second lateral edges, a top longitudinal edge attached to a portion of the peripheral edge of the first panel, and a bottom longitudinal edge attached to a portion of the peripheral edge of the second panel; and
a second side panel having opposed first and second lateral edges, a top longitudinal edge attached to a portion of the peripheral edge of the first panel, and a bottom longitudinal edge attached to a portion of the peripheral edge of the second panel;
the first lateral edges of the first and second side panels being attached to each other.

16. The pet sleeping bag of claim 15 wherein the outer and inner sleeves each further comprise:
a first neck panel having a side edge attached to the second lateral edge of the first side panel, a top edge attached to a portion of the peripheral edge of the first panel, and a bottom edge attached to a portion of the peripheral edge of the second panel; and
a second neck panel having a side edge attached to the second lateral edge of the second side panel, a top edge attached to a portion of the peripheral edge of the first panel, and a bottom edge attached to a portion of the peripheral edge of the second panel.

17. The pet sleeping bag of claim 16 wherein:
the second lateral edges of the first and second side panels are each of a first width;
the side edges of the first and second neck panels are each of a second width which is less than the first width; and
the side edges of the first and second neck panels are attached to respective ones of the second lateral edges of the first and second side panels by gather stitches.

18. The pet sleeping bag of claim 17 wherein the first and second panels, the first and second side panels, and the first and second neck panels are each fabricated from an acrylic fur material.

19. The pet sleeping bag of claim 18 wherein:
the acrylic fur material has a furry side and a non-furry side;
the outer sleeve is fabricated such that the interior compartment thereof is defined by the non-furry side of the acrylic fur material and an exterior surface of the outer sleeve is defined by the furry side of the acrylic fur material; and
the inner sleeve is fabricated such that the interior compartment thereof is defined by the furry side of the acrylic fur material and an exterior surface of the inner sleeve is defined by the non-furry side of the acrylic fur material.

20. The pet sleeping bag of claim 17 wherein the first and second panels, the first and second side panels, and the first and second neck panels are attached to each other through the use of stitched seams.
